(19) United States
(12) Patent Application Publication
(10) Pub. No.: US 2008/0134303 A1
(43) Pub. Date: Jun. 5, 2008

(54) Communication Apparatus, Communication Apparatus Protecting Method and Program

(76) Inventor: Junichi REKIMOTO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/942,535

(22) Filed: Nov. 19, 2007

(30) Foreign Application Priority Data
Nov. 20, 2006 (JP) 2006-313428

(51) Int. Cl. H04L 9/32

(52) U.S. Cl. 726/4

(57) ABSTRACT

A communication apparatus capable of wireless communications with one or more base stations is disclosed. The communication apparatus includes a receiving unit configured to receive a signal transmitted from the base station, a judging unit configured to judge whether the communication apparatus is located in an area satisfying a predetermined criterion, in accordance with the signal received at the receiving unit, and an authentication unit configured to perform an authentication process for a user of the communication apparatus if the judging unit judges that the communication apparatus is not located in the area satisfying the criterion.

### BACKGROUND OF THE INVENTION

1. Field of the Invention

The present invention relates to a communication apparatus, a communication apparatus protecting method and a program.

2. Description of Related Art

A receiving apparatus capable of receiving radio signals transmitted from a satellite is mounted nowadays on a mobile object such as a vehicle and a mobile phone. According to position measurement of a global positioning system (GPS), it is possible to estimate the position of a mobile object mounting the receiving apparatus of this type. The position estimating techniques using the receiving apparatus of this type are common infrastructural techniques important in a variety of fields such as navigation, security and amusement.

There arises a recent issue of leakage and theft of information stored in a portable terminal such as a note type personal computer (PC) and a mobile phone. In order to settle this issue, it is a general method that entire data in a hard disk is enciphered and a user is allowed to access the data only when the user can be authenticated by using a password or a fingerprint to protect data stored in a portable terminal.

Japanese Unexamined Patent Application Publication No. 2002-352363(Japanese Patent Application No. 2001-154026) discloses a security system utilizing the position estimating techniques. In this security system, a portable terminal, which obtained position information of the terminal basing upon measurement by GPS, transmits the position information of the terminal to a security control apparatus, and the security control apparatus judges a home security state in accordance with the position information of the portable terminal.

### SUMMARY OF THE INVENTION

However, with the current technology security system, if a portable terminal is located in the interior of a house or an underground room where radio signals from a satellite cannot reach the portable terminal, it is difficult to synchronously capture and hold radio signals from the satellite. Further, although the current security system judges a home security state, the security system does not protect the portable terminal if the terminal is robbed.

The present invention has been made in view of the above-described issue. According to embodiments of the present invention, there are provided novel and improved communication apparatus, communication apparatus protecting method and program capable of performing an authentication process for a user of the communication apparatus such as a wireless terminal if the communication apparatus is moved outside an area satisfying a predetermined criterion.

In order to settle the above-described issue, according to one aspect of the present invention, there is provided a communication apparatus capable of wireless communications with one or more base stations, including: a receiving unit for receiving a signal transmitted from the base station; a judging unit for judging whether the communication apparatus is located in an area satisfying a predetermined criterion, in accordance with the signal received at the receiving unit; and an authentication unit for performing an authentication process for a user of the communication apparatus if the judging unit judges that the communication apparatus is not located in the area satisfying the criterion.

With this arrangement, the judging unit judges whether the communication apparatus is located in an area satisfying a predetermined criterion, in accordance with the signal received at the receiving unit. The authentication unit performs an authentication process for a user of the communication apparatus by requesting a password, a fingerprint or the like from the user if the judging unit judges that the communication apparatus is not located in the area satisfying the criterion. Further, for example, if a non-alarm area where a user authentication is not imposed on the user is set to the communication apparatus automatically or in accordance with a user operation, as the area satisfying the predetermined criterion, and if the communication apparatus is moved to the alarm area outside the non-alarm area, the user authentication is imposed upon the user. Accordingly, if the communication apparatus such as PC and a mobile phone is stolen by others and moved to the alarm area not intended by the genuine user, the communication apparatus detects use of the communication apparatus by the others. Namely, if the area having a high possibility that the communication apparatus is carried by the genuine user is set as the non-alarm area, it is possible to suppress the cumbersome user authentication from being requested to the genuine user, and to impose effectively the user authentication upon a third party stole the communication apparatus.

The communication apparatus may further include a measuring unit for measuring a signal intensity of each signal received at the receiving unit. The judging unit may judge whether the communication apparatus estimated from the signal intensity measured by the measuring unit and known position information of the base station, is located in the area satisfying the criterion. With this arrangement, for example, the communication apparatus transmits information on the signal intensity measured by the measuring unit to a position estimating server which stores base station information correlating base station identification information with position information of a base station. The communication receives position information of the communication apparatus estimated by the position estimating apparatus from the base station information and information on the signal intensity. If the user sets as the area satisfying the criterion an area, for example, between a home of the user and a site frequently called by the user such as a work office and a school, to the communication apparatus, the judging unit judges from the estimated position information whether the communication apparatus is located in the set area.

The communication apparatus may further includes a notifying unit for notifying the estimated position of the communication apparatus to a registered contact site if the authentication unit cannot authenticate a user of the communication apparatus. With this arrangement, for example, if the communication apparatus is stolen by others and the others tries to use the communication apparatus, there is a high possibility that a user authentication request is imposed upon the others because the communication apparatus is moved outside the area satisfying the criterion. However, the authentication request for use of the communication apparatus is issued in many cases nowadays, and it is considered that the others accepts without any doubt the authentication request for use of the communication apparatus. Under this circumstance, just when the authentication unit does not authenticate the others, the notifying unit transmits the estimated position information of the communication apparatus to a mail address or the like of the genuine user registered beforehand, without being noticed by the others. It is therefore possible for the genuine user to recognize the location of the communication apparatus and find the communication apparatus.

The authentication unit may perform the authentication process for the user of the communication apparatus while the position of the communication apparatus cannot be estimated. When the judging unit judges from the estimated position information whether the communication apparatus is in the area satisfying the criterion, the judging unit cannot judge whether the communication apparatus is actually in the area satisfying the criterion while the position of the communication apparatus cannot be estimated. In this case, it is not possible to distinguish between that the communication apparatus is carried by the genuine user and that the communication apparatus was stolen by others. Accordingly, the authentication unit performs the authentication process for a user so that safety of the communication apparatus can be assured.

The authentication unit may perform the authentication process for the user of the communication apparatus, at a predetermined time interval, while the position of the communication apparatus cannot be estimated. With this arrangement, the genuine user can use the communication apparatus if the authentication process is performed at the predetermined time interval, whereas if the communication apparatus is stolen by others, it is possible to prevent use of the communication apparatus by the others during a period longer than one predetermined time interval.

The preset area may be variable in accordance with a timing of judging by the judging unit. With this configuration, if a destination site of the user of the communication apparatus is already determined by a timing such as a time of day, days and week of days, only the destination site is set as the preset area at a corresponding time so that the communication apparatus can be protected at a higher precision.

The communication apparatus may further include a storage unit capable of storing base station identification information uniquely assigned to the base station or each of the base stations, wherein the judging unit compares base station identification information indicating a transmission source of each signal received at the receiving unit with the base station identification information stored in the storage unit, to judge whether the communication apparatus is located in the area satisfying the criterion. With this arrangement, the communication apparatus judges whether the communication apparatus is located in the area satisfying the criterion, by merely comparing the base station identification information indicating a transmission source of a received signal with the base station identification information stored in the storage unit, without measuring a signal intensity at the communication apparatus and obtaining the position information of the communication apparatus. Namely, the communication apparatus is not required to have a signal intensity measuring function, the storage unit for base station information and a communication apparatus position estimating function. It is therefore possible to simplify the structure of the communication apparatus and reduce cost.

The judging unit may judge that the communication apparatus is not located in the area satisfying the criterion, if the number or a ratio of pieces of the base station identification information indicating the transmission source of each signal received at the receiving unit, relative to pieces of the base station identification information stored in the storage unit, is smaller than a first boundary value. With this arrangement, the area satisfying the criterion corresponds to an area where the number or a ratio of signals capable of being received from base stations corresponding to base station information stored in the storage unit is larger than the first boundary value. Therefore, if there are few or no signals capable of being received from base stations corresponding to base station information stored in the storage unit 220, the judging unit can judge that the communication apparatus is not located in the area satisfying the criterion.

The judging unit may judge that the communication apparatus is not located in the area satisfying the criterion, if the number or a ratio of pieces of the base station identification information indicating the transmission source of each signal received at the receiving unit, relative to pieces of the base station identification information not stored in the storage unit, is larger than a second boundary value. With this arrangement, the area satisfying the criterion corresponds to an area where the number or a ratio of signals capable of being received from base stations corresponding to base station information not stored in the storage unit is smaller than the second boundary value. Therefore, if there are many signals capable of being received from base stations corresponding to base station information stored in the storage unit, the judging unit can judge that the communication apparatus is not located in the area satisfying the criterion.

The communication apparatus may further include a data processing unit 7 for storing, in the storage unit, base station identification information indicating the transmission source of each signal received at the receiving unit, and not stored in the storage unit, if the authentication unit authenticates the user of the communication apparatus. With this arrangement, since the base station identification information is stored automatically in the storage unit, a work of setting an area desired by the user to the communication apparatus can be omitted. Namely, with this data processing, it is possible to set a new area easily to the communication apparatus and solve a problem that a user is forced to set basic positions of the position range of the new area such as a latitude, a longitude and an address, each time the communication apparatus is moved to the new area.

If the receiving unit does not receive a signal over a predetermined time, the data processing unit may delete the base station identification information from the storage unit. With this arrangement, the data processing unit updates automatically the area satisfying the criterion. Namely, if the base station identification information is stored in the storage unit at a working site once called by a user, the judging unit recognizes this working site also as the area satisfying the criterion. If the number of pieces of base station identification information at sites having a low possibility that the user calls again increases in the base station identification information stored in the storage unit, the range recognized by the judging unit as the area satisfying the criterion becomes excessively broad. The data processing unit can therefore erase properly the base station identification information corresponding to the site the user called only by chance, from the storage unit, to thereby optimize the range recognized by the judging unit as the area satisfying the criterion.

The communication apparatus may further include an inhibiting unit for inhibiting use of the communication apparatus if the authentication unit does not authenticate the user of the communication apparatus. With this arrangement, since use of the communication apparatus by a third party is inhibited, it is possible to prevent leakage of information stored in the communication apparatus and identity theft of the genuine user by a third party.

In order to settle the above-described issue, according to another aspect of the present invention, there is provided a communication apparatus protecting method for a communication apparatus capable of wireless communications with one or more base stations, the method including the steps of: receiving a signal transmitted from the base station; judging whether the communication apparatus is located in an area satisfying a predetermined criterion, in accordance with the received signal; and performing an authentication process for a user of the communication apparatus, if it is judged that the communication apparatus is not located in the area satisfying the criterion.

In order to settle the above-described issue, according to still another aspect of the present invention, there is provided a program for making a computer function as a communication apparatus, the communication apparatus being capable of wireless communications with one or more base stations and comprising: receiving means for receiving a signal transmitted from the base station; judging means for judging whether the communication apparatus is located in an area satisfying a predetermined criterion, in accordance with the signal received at the receiving unit; and authenticating means for performing an authentication process for a user of the communication apparatus if the judging means judges that the communication apparatus is not located in the area satisfying the criterion.

As described above, according to the communication apparatus, communication apparatus protecting method and program, an authentication process can be performed for a user of a communication apparatus such as a wireless terminal, if the communication apparatus moves outside the area satisfying the predetermined criterion.

### BRIEF DESCRIPTION OF THE DRAWINGS

FIG. 1 is an illustrative diagram showing the configuration of a communication apparatus protecting system according to a first embodiment of the present invention.

FIG. 2 is a functional block diagram showing the structures of a portable PC and a position estimating apparatus according to the first embodiment.

FIG. 3 is an illustrative diagram showing an example of signal intensity information.

FIG. 4 is an illustrative diagram showing an example of base station information stored in a base station information storage unit.

FIG. 5 is a flow chart illustrating an operation sequence of a communication apparatus protecting method according to one embodiment of the present invention.

FIG. 6 is a functional block diagram showing the structure of a portable PC according to a second embodiment of the present invention.

FIG. 7 is an illustrative diagram showing the operation sequence of the portable PC of the second embodiment.

### DETAILED DESCRIPTION OF THE EMBODIMENTS

With reference to the accompanying drawings, preferred embodiments of the present invention will be described in detail. In the specification and drawings, constituent elements having substantially the same function and structure are represented by identical symbols, and the duplicated description thereof is omitted.

### First Embodiment

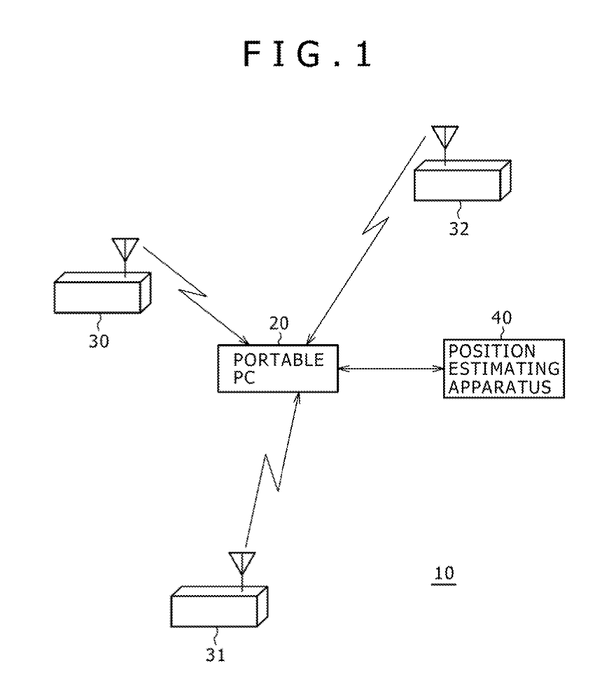

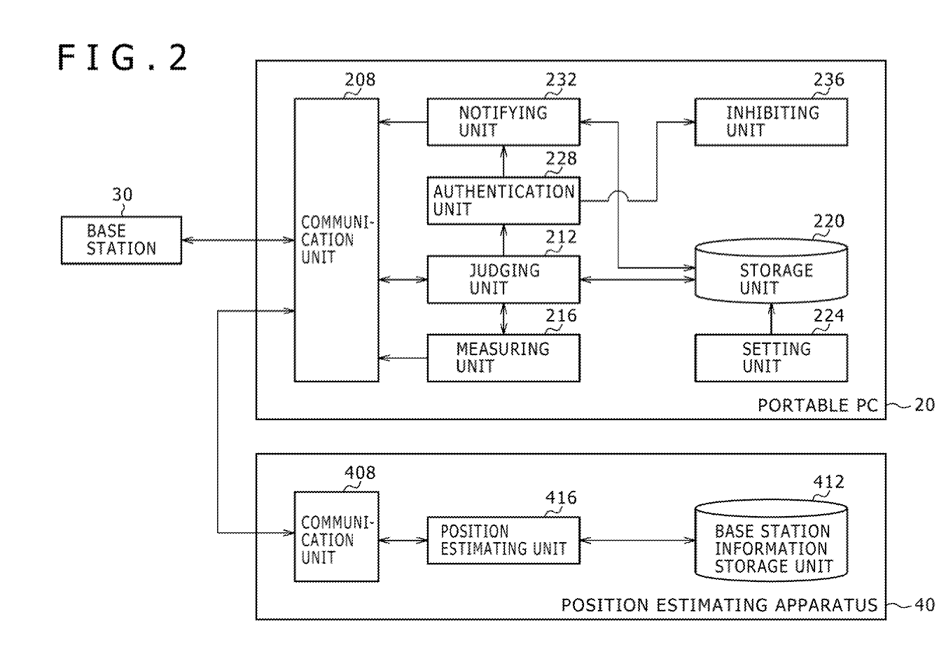

Description will be made first on a communication apparatus protecting system 10 according to the first embodiment. In the description of the first embodiment, after the outline of the communication apparatus protecting system 10 of the first embodiment is described with reference to FIG. 1, each structure of the communication apparatus protecting system 10 is described with reference to FIGS. 2 to 5.

FIG. 1 is an illustrative diagram showing the configuration of the communication apparatus protecting system 10 according to the first embodiment. The communication apparatus protecting system 10 includes a portable PC 20, base stations 30, 31 and 32 and a position estimating apparatus 40.

The base stations 30, 31 and 32 relay communications among communication apparatus spatially distributed. For example, the base stations 30, 31 and 32 relays wireless communications between the portable PC 20 and another wireless terminal (not shown) existing in a radio wave arriving area of each base station, and relays communications with communication apparatus wired to the portable PC 20 and base station 30, 31 or 32.

More specifically, the base station 30 may be a base station of a wireless local area network (LAN) in conformity with the wireless fidelity (WiFi) specifications, a base station of global system for mobile communications (GSM), a base station of a portable phone or a personal handyphone system (PHS), a short distance wireless base station of Bluetooth, or the like. The structures of the base stations 30, 31 and 32 are substantially the same. Therefore, the base station 30 is used by way of example in the following description.

The base station 30 transmits periodically a beacon signal for notifying the surroundings of an existence of the base station 30, in addition to a signal which is transmitted when wireless communications are relayed. The beacon signal includes a base station ID, e.g., base station identification information uniquely assigned to the base station 30. The portable PC 20 therefore confirms an existence of the base station 30 in the surroundings, in accordance with the base station ID in the received beacon signal.

The portable PC (personal computer) 20 transmits/receives various data over wireless communications under control by the base station 30. For example, the portable PC 20 receives contents data from a contents distribution server (not shown) via the base station, and transmits/receives an e-mail to/from another wireless terminal (not shown). The contents data may be arbitrary data such as music data including music, lectures, radio programs and the like, video data including movies, television programs, video programs, photographs, pictures, figures, tables and the like, games, software and the like.

In FIG. 1, the portable PC 20 is shown as just an example of a communication apparatus equipped with a function of receiving a signal transmitted from the base station 30. The communication apparatus may be an information processing apparatus including a desk-top type PC, a home video processing apparatus (such as a DVD recorder and a video deck), a mobile phone, a PHS, a portable music reproducing apparatus, a portable video processing apparatus, a personal digital assistant (PDA), a home game apparatus, a portable game apparatus, and a home electric apparatus.

Upon reception of a signal (e.g., a beacon signal) transmitted from the base station 30, 31 or 32, the portable PC 20 measures an intensity of the signal, correlates the measured signal intensity with the base station ID of the base station 30, 31 or 32 and transmits the signal intensity correlated with the base station ID to the position estimating apparatus 40 as signal intensity information. Communication methods for communications between the portable PC 20 and position estimating apparatus 40 are not specifically defined, but a communication method via a communication network may also be adopted.

The position estimating apparatus 40 stores beforehand base station information representative of the position information indicating installation positions of the base stations 30, 31 and 32 correlated with the base station ID, and has a function of estimating the position of the portable PC 20, for example, by the triangulation techniques, in accordance with the signal intensity information received from the portable PC 20 and the base station information. The position estimating apparatus 40 transmits as position information the estimated position information to the portable PC 20, and the portable PC 20 can recognize its terminal position from the position information notified by the position estimating apparatus 40. The position estimating apparatus 40 responds to a position estimating request not only from the portable terminal PC 20 but also from a plurality of other wireless terminals.

The portable PC 20 of this embodiment changes the security level in accordance with the position information received from the position estimating apparatus 40. For example, if the portable PC 20 is moved outside a non-alarm area previously set as an area satisfying a predetermined criterion, the portable PC 20 imposes a user authentication upon a user of the portable PC 20.

Namely, if the portable PC 20 is stolen by others and moved to an alarm area outside the non-alarm area specified by the owner (i.e. the genuine user), the user authentication is imposed upon the others so that use of the portable PC 20 by the others can be effectively prevented. In the following, description will be made on the detailed structures and operations of the portable PC 20 and position estimating apparatus 40 which realize such a function, with reference to FIGS. 2 to 5.

FIG. 2 is a functional block diagram showing the structures of the portable PC 20 and position estimating apparatus 40 of one embodiment. The portable PC 20 includes a communication unit 208, a judging unit 212, a measuring unit 216, a storage unit 220, a setting unit 224, an authentication unit 228, a notifying unit 232 and an inhibiting unit 236. The position estimating unit 40 has a communication unit 408, a base station information storage unit 412 and a position estimating unit 416.

The communication unit 208 is an interface with surrounding of the base station 30 and the position estimating apparatus 40, and has a function as a receiver and a transmitter. More specifically, the communication unit 208 receives a signal (e.g., a beacon signal) transmitted from surrounding of the base station 30. The communication unit 208 transmits signal intensity information to be described later, to the position estimating apparatus 40. The communication unit 208 may be a wireless LAN compatible communication apparatus, a GSM compatible communication apparatus or a Bluetooth compatible communication apparatus.

The judging unit 212 judges various conditions when a communication apparatus protecting method is to be performed by the portable PC 20. For example, the judging unit 212 judges whether the communication unit 208 of the portable PC 20 can communicate with the position estimating apparatus 40. The judging unit 212 also judges whether the position information of the portable PC 20 obtained from the position estimating apparatus 40 indicates that the portable PC 20 is in the set non-alarm area or not. Information on the range of the non-alarm area may be stored in the storage unit 220, and the judging unit 212 may judge whether the position information of the portable PC 20 obtained from the position estimating apparatus 40 indicates that the portable PC 20 is in the non-alarm area or not, by comparing the range of the non-alarm area stored in the storage unit 220 with the position information of the portable PC 20 obtained from the position estimating apparatus 40.

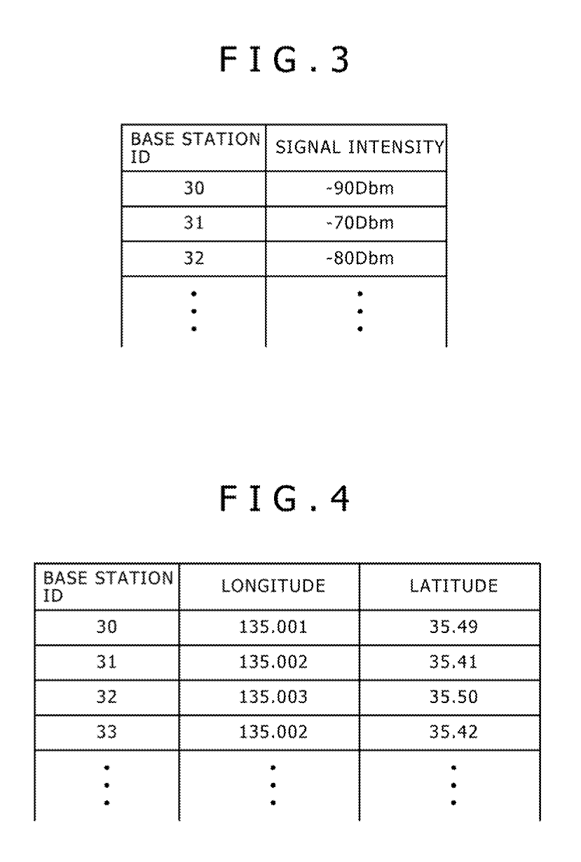

The measuring unit 216 measures a signal intensity of a signal received by the communication unit 208. As shown in FIG. 3, the signal intensity information correlating the signal intensity with the base station ID representative of a signal transmission source, is transmitted to the position estimating apparatus 40 via the communication unit 208.

FIG. 3 is an illustrative diagram showing an example of the signal intensity information. As shown in FIG. 3, the signal intensity information correlates the base station ID of each base station with a signal intensity of a signal transmitted from the base station and received at the portable PC 20. In the example shown in FIG. 3, a signal intensity of a signal transmitted from the base station 30 having the base station ID “30”, and received at the portable PC 20, is “−90 Dbm”, a signal intensity of a signal transmitted from the base station 31 having the base station ID “31”, and received at the portable PC 20, is “−70 Dbm”, and a signal intensity of a signal transmitted from the base station 32 having the base station ID “32”, and received at the portable PC 20, is “−80 Dbm”.

The signal intensity information is not limited to having the structure shown in FIG. 3. For example, since a signal transmitted from the base station attenuates its signal strength as the distance from the base station becomes long in accordance with a predetermined rule, it is therefore possible to calculate the distance between the base station transmitted the signal and the portable PC 20, from the signal intensity of the signal at the portable PC 20. Therefore, the signal intensity information may have the structure that the base station ID of the base station is correlated with the distance between the base station and portable PC 20 being as information obtained from the signal intensity.

Description will then be directed to the position estimating apparatus 40 side. The communication unit 408 is an interface with the portable PC 20. More specifically, the communication unit receives the signal intensity information from the portable PC 20, and transmits the position information to the portable PC 20. The communication unit 408 transmits/receives information relative to not only one portable PC 20 but also two or more of any information processing apparatus.

The base station information storage unit 412 stores, as the base station information, the base station ID of a base station performing wireless communications with the portable PC 20, correlated with the position information indicating an installation position of the base station. An example of the base station information stored in the base station information storage unit 412 will be described with reference to FIG. 4.

FIG. 4 is an illustrative diagram showing an example of the base station information stored in the base station information storage unit 412. As shown in FIG. 4, the base station information storage unit 412 stores, as known base station information, the base station ID correlated with the longitude and latitude as position information of the base station. More specifically, the base station 30 having the base station ID “30” is registered in the base station information storage unit 412 as installed at a longitude (east longitude) “135.001” and a latitude (north latitude) “35.49”.

Similarly, the base station 31 is registered in the base station information storage unit 412 as installed at a longitude “135.002” and a latitude “35.41”, the base station 32 is registered in the base station information storage unit 412 as installed at a longitude “135.002” and a latitude “35.50”, and the base station 33 is registered in the base station information storage unit 412 as installed at a longitude “135.002” and a latitude “35.42”.

The format of position information to be stored in the base station information storage unit 412 is not limited to the format using longitude and latitude, but may be the format using x, y coordinates, the format using polar coordinates or the format using vector.

The base station information storage unit 412 may be a storage medium including: a non-volatile memory such as an electrically erasable programmable read-only memory (EEPROM) and an erasable programmable read-only memory (EPRPM); a magnetic disk such as a hard disk and a disk type magnetic medium; an optical disc such as compact disk recordable (CD-R)/rewritable (RW), digital versatile disk recordable (DVD-R)//RW/+R/+RW/random access memory (RAM) and Blu-Ray Disc® (DB)-R/BD-RE; and a magneto optical (MO) disc.

The position estimating unit 416 estimates position information of the portable PC 20 from the following equation (1), by using the signal intensity information received from the portable PC 20 and the base station information registered in the base station information storage unit 412.

$$\begin{matrix}O = \frac{1}{W} \cdot {\sum }_{i} ( Wi \cdot Ai ) & ( equation 1 ) \\ Wi = \frac{1}{distS ( O , Ai )} & ( equation 2 ) \\ W = {\sum }_{i} Wi & ( equation 3 )\end{matrix}$$

In the equation (1), Ai represents position information of an i-th base station registered in the base station information storage unit. If the base station information is represented by the longitude and latitude as shown in FIG. 4, the equation (1) is applied to each longitude and latitude. As shown in an equation (2), Wi is a weight coefficient obtained basing upon distS (O, Ai) indicating a distance between the portable PC 20 estimated from the signal intensity and the i-th base station. As shown in an equation (3), W is a total sum of weight coefficients.

As seen from the equation (1), position information of a base station having a short distS (O, Ai) is reflected greatly upon the position O of the portable PC 20 estimated at each measurement time. Position information of the base station having a long distS (O, Ai) has less influence upon the estimated O of the portable PC 20.

By using the equation (1), the position estimating unit 416 can rationally estimate the position O of the portable PC 20. The position estimating unit 416 transmits the position information indicating the position O estimated by the position estimating unit 416 and correlated to the measurement time to the portable PC 20.

Namely, the position estimating unit 416 returns the signal intensity information received from the portable PC 20 by converting the signal intensity information into the position information such as “135.002 35.46”. Alternatively, the position estimating unit 416 returns the signal intensity information received from the portable PC 20 by converting the signal intensity information into an address such as “AB prefecture, C-ku, 5-chome”, to the portable PC 20.

A position estimating method for the portable PC 20 is not limited to the method using the equation (1), but, for example, the position of the base station which transmitted a signal received at the portable PC 20 at the highest signal intensity, may be estimated as the position of the portable PC 20. Alternatively, the center position of base stations which transmitted signals received at the portable PC 20 at a level equal to or higher than a predetermined threshold value, may be estimated as the position of the portable PC 20.

The position estimating apparatus 40 having the position estimating unit 416 described above can estimate the position of the portable PC 20, for example, in accordance with a signal intensity of a signal received at the portable PC 20 compatible with wireless LAN from the wireless LAN base station. There is a high possibility that the wireless LAN base station is installed at a variety of positions including an underground room, the interior of a house and the like. If the portable PC 20 is compatible with wireless LAN, the position estimating apparatus 40 can estimate the position of the portable PC 20 in accordance with the signal intensity measured at the portable PC 20, irrespective of whether the portable PC 20 exists in an underground room or the interior of a house.

Returning back to the description of the structure of the portable PC 20, the storage unit 220 stores the range of the non-alarm area set by the setting unit 224, and a contact site such as a mail address or a telephone number of an owner of the portable PC 20. A method of defining the range of the non-alarm area as the area satisfying the predetermined criterion is not specifically defined, but any method may be adopted. For example, a partial area or the entire area of the non-alarm area may be defined as a circular area having some position as its center, may be defined by an address such as Shinagawa-ku Ohsaki and Meguro-ku Meguro Honmachi, may be defined by the longitude and latitude such as an east longitude from 135.002 to 135.003 and a north latitude from 35.45 to 35.46, may be defined by station names along a rail route from Gotanda to Shinagawa, or may be defined by a name of a location such as a recreation ground, a park and a building.

The range of the non-alarm area may be made variable in accordance with a timing such as a time of day, a day and a day of week. For example, if the user of the portable PC 20 is an office worker, the worker moves between the home and office in most cases in week days, and there is a high possibility in holidays that the worker makes shopping and goes to leisure facilities such as movies, concerts, recreation grounds. The storage unit 220 may store the area between the home and office in week days as the non-alarm area, and the whole non-alarm area in holidays.

If the user of the portable PC 20 takes a sleep time from p.m. 11 to a.m. 7 regularly, it can be considered that the portable PC 20 is in the user's home from p.m. 11 to a.m. 7. Therefore, the storage unit 220 may set the non-alarm area from p.m. 11 to a.m. 7 to only the home.

If the user has a habit of going to a bank on a pay day of every month, the storage unit 220 may additionally set the bank to the non-alarm area on the pay day of the user.

Since the contact site stored in the storage unit 220 is used for notifying a theft of the portable PC 20, from the portable PC 20, when the portable PC 20 is stolen or in other cases, the contact site is not limited only to the mail address or telephone number of the owner, but a police alarm reception site, a contact site of the maker of the portable PC 20 or a contact site of a security company may also be used.

The storage unit 220 may store a password, a fingerprint, media information, voice information, iris information, face information or the like to be used when a user authentication is performed for a user of the portable PC 20.

Similar to the base station information storage unit 412, the storage unit 220 may be a storage medium including: a non-volatile memory such as EEPROM and EPRPM; a magnetic disk such as a hard disk and a disk type magnetic medium; an optical disc such as CD-R/RW, DVD-R/RW/+R/+RW/RAM and BD®-R/BD-RE; and an MO disc.

The setting unit 224 sets each prerequisite for execution of the communication apparatus protecting method for the portable PC 20. For example, the setting unit 224 can set the range of the non-alarm area as an area satisfying the predetermined criterion, either manually or in accordance with a user operation, and store the range in the storage unit 220. The setting unit 224 can also set the contact site such as an e-mail address or telephone number of an owner of the portable PC 20 in the storage unit 220.

The authentication unit 228 performs the authentication process for a user of the portable PC 20, if the judging unit 212 judges that the position of the portable PC is not in the alarm area. The authentication process may use, as a personal confirmation method of confirming an authorized user of the personal PC 20, for example, a password authenticating method of requesting a password from a user and authenticating the user in accordance with whether the input password matches a password stored in the storage unit 220.

Further, the authentication process may use a fingerprint authenticating method of requesting a finger print from a user and authenticating the user in accordance with whether the input fingerprint is analogous to or matches a fingerprint stored in the storage unit 220. Furthermore, the authentication process may use a medium authenticating method of requesting a near contact operation of an IC card from a user and authenticating the user in accordance with whether information on the IC card in near contact matches the information on an IC card stored in the storage unit 220. Further, the authentication process may use a voice authentication method using voices of a user, an iris or retina verification method based on the pattern of an iris or retina of a user, a face authentication method based on the look of a face of a user, or the like.

If the portable PC 20 is stolen by others and moved to the alarm area not intended by the genuine user, the authentication unit 228 of the portable PC 20 can impose a user authentication upon the others. Namely, the portable PC 20 suppresses the case that the genuine user is requested for a cumbersome personal authentication, if the area where the genuine user carries the portable PC is set to the non-alarm area, whereas the personal authentication is imposed effectively upon others who stole the personal PC 20.

If the portable PC 20 cannot obtain position information of the portable PC 20 under a circumstance that the portable PC 20 cannot access the position estimating apparatus 40 or in other cases, the authentication unit 228 may perform an authentication process for a user of the portable PC 20 at a predetermined time interval. For example, after one authentication process, the authentication unit 228 can perform again an authentication process after a lapse of a set wait time.

In this case, the judging unit 212 judges from the estimated position information whether the portable PC 20 is in the non-alarm area. Therefore, while the position of the portable PC 20 cannot be estimated, the judging unit 212 cannot judge whether the portable PC 20 is actually in the non-alarm area. In this case, it is not possible to distinguish between that the portable PC 20 is carried by the genuine user and that the portable PC 20 was stolen by others. However, the authentication unit 228 performs the authentication process for a user so that safety of the portable PC 20 is assured.

Further, the authentication unit 228 performs the authentication process at the predetermined time interval if position information of the portable PC 20 cannot be obtained. With this arrangement, the genuine user can use the portable PC 20 if the genuine user undergoes the authentication process at a predetermined time interval, whereas if the portable PC 20 is stolen by others, it is possible to prevent the others from using the portable PC 20 during a period equal to or longer than one predetermined time interval. The setting unit 224 may set the predetermined time interval to an arbitrary value set by a user operation.

It is, however, cumbersome that while the genuine user uses the portable PC 20, the genuine user is requested for the authentication at a predetermined time interval. Therefore, during the time period while the position information of the portable PC is not obtained, the authentication unit 228 may perform the authentication process if the user operation is not detected during a predetermined time period. This predetermined time period may be set to an arbitrary value by the setting unit 224 in accordance with a user operation.

If the position information of the portable PC 20 is estimated and the authentication unit 228 does not authenticate a user of the portable PC 20, the notifying unit 232 notifies the estimated position information of the portable PC 20 to the contact site registered beforehand in the storage unit 220.

With this notifying unit 232, if for example the portable PC 20 is stolen by others and tried to use the portable PC 20, there is a high possibility that the portable PC 20 is moved outside the non-alarm area and the user authentication is imposed upon the others. However, the authentication request for use of the portable PC 20 is issued in many cases nowadays, and it is considered that the others, who stole the portable PC 20, accepts without any doubt the authentication request for use of the portable PC 20. Under this circumstance, just when the authentication unit 228 does not authenticate the others, the notifying unit 232 transmits the estimated position information of the portable PC 20 to a mail address or the like of the genuine user registered beforehand, without being noticed by the others who stole the portable PC 20. It is therefore possible for the genuine user to recognize the location of the stolen portable PC 20. Namely, the notifying unit 232 can help find earlier the case the portable PC 20 was stolen.

The inhibiting unit 236 inhibits the use of the portable PC 20 if the authentication unit 228 cannot authenticate a user of the portable PC 20. For example, the inhibiting unit 236 turns off the power source of the portable PC 20. Since use of the portable PC 20 by others can be inhibited, it is possible to prevent leakage of information stored in the portable PC 20 and identity theft of the genuine user by others.

A computer program may be created which makes hardware of a CPU, a ROM, a RAM and the like built in the portable PC 20 exhibit similar functions to those of the constituent elements of the portable PC 20.

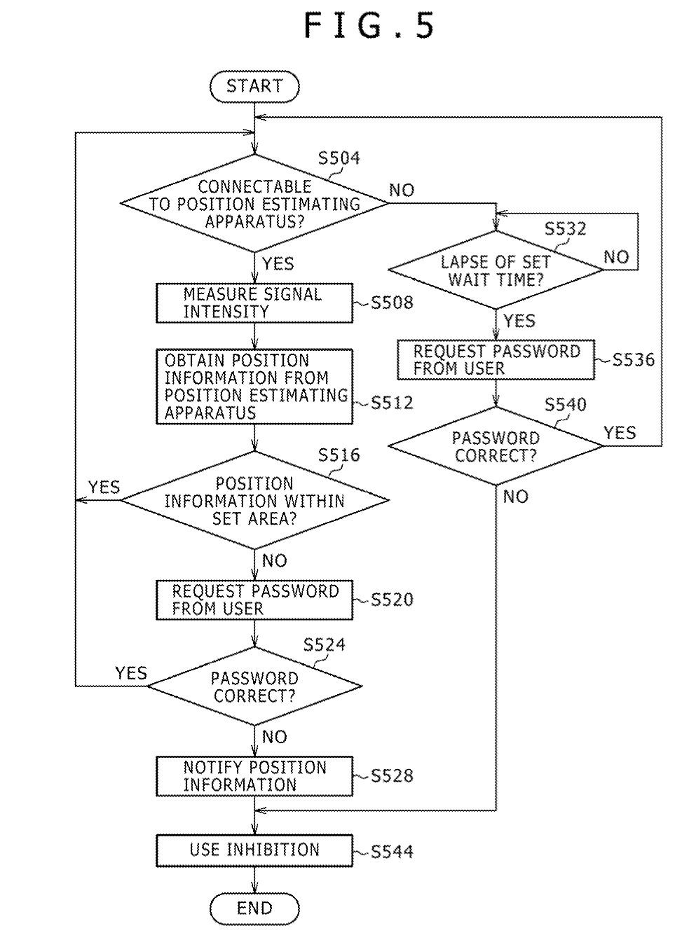

The configuration of the communication apparatus protecting system 10 of embodiments has been described above. Next, with reference to FIG. 5, description will be made on the communication apparatus protecting method for the communication apparatus protecting system 10 of one embodiment of the present invention.

FIG. 5 is a flow chart illustrating the operation sequence of the communication apparatus protecting method according to one embodiment of the present invention. First, the judging unit 212 of the portable PC 20 judges whether the portable PC 20 can be connected to the position estimating apparatus 40 (S504). If it is judged by the judging unit 212 that the position estimating apparatus 40 is connectable, the measuring unit 216 measures a signal intensity. Thereafter, the portable PC 20 transmits signal intensity information based on the signal intensity measured by the measuring unit 216 to the position estimating apparatus 40 to obtain position information of the portable PC 20 estimated based on the signal intensity information from the position estimating apparatus 40 (S512).

Next, the judging unit 212 judges whether the position information obtained from the position estimating apparatus 40 indicates that the portable PC 20 is in a set area (S516). If it is judged by the judging unit 212 judges that the portable PC 20 is in the set area, the flow returns to the process at S504. If it is judged by the judging unit 212 that the portable PC 20 is outside the set area, the authentication unit 228 requests a password from a user (S520). The authentication unit 228 authenticates the password entered by the user (S524).

If it is judged at S524 by the authentication unit 228 that the input password is correct, the flow returns to the process at S504. If it is judged by the authentication unit 228 that the input password is incorrect, the notifying unit 232 notifies the position information of the portable PC 20 to the contact site previously registered (S544).

If it is judged at S504 by the judging unit 212 that the position estimating apparatus 40 is not connectable, the judging unit 212 or authentication unit 228 judges whether a set wait time has elapsed (S532). If the set wait time has not elapsed, the process at S532 is repeated until the set wait time elapses. If it is judged at S532 that the set wait time has elapsed, the authentication unit 228 requests a password from a user (S536). The authentication unit 228 authenticates the password entered by the user (S540).

If it is judged at S540 by the authentication unit 228 that the input password is correct, the flow returns to the process at S504. If it is judged by the authentication unit 228 that the input password is incorrect, the flow proceeds to the process at S544. After the process at S528 or after the process at S540, the inhibiting unit 236 inhibits use of the portable PC 20 by the user (S544).

As described above, according to the communication apparatus protecting method of the first embodiment of the present invention, if the portable PC 20 moves outside the set non-alarm area, a user authentication can be imposed upon a user of the portable PC 20. Further, if the user of the portable PC 20 cannot be authenticated, the position information of the portable PC 20 can be notified to a previously registered contact site, e.g., a contact site of the genuine user of the portable PC 20. It is therefore possible for the genuine user to recognize the location of the stolen portable PC 20 and find the portable PC 20. Namely, the portable PC 20 of this embodiment can help find earlier the case the portable PC 20 was stolen.

Further, the portable PC 20 of this embodiment has the inhibiting unit 236 for inhibiting use of the portable PC 20 when the authentication unit 228 cannot authenticate a user of the portable PC 20. Therefore, since the inhibiting unit 236 inhibits use of the portable PC 20 by others such as a theft, it is possible to prevent leakage of information stored in the portable PC 20 and identity theft of the genuine user by others.

Further, the authentication unit 228 of the portable PC 20 of this embodiment can impose a user authentication at a predetermined period if the position information of the portable PC 20 cannot be obtained. Therefore, if it is not possible to distinguish between that the portable PC 20 is carried by the genuine user and that the portable PC 20 was stolen by others, an authentication process for a user is performed so that safety of the portable PC 20 can be assured.

### Second Embodiment

Next, description will be made on a portable PC according to the second embodiment of the present invention. In the portable PC 20 of the first embodiment, the judging unit 212 judges whether the estimated position information of the portable PC 20 indicates that the portable PC 26 is in the non-alarm area. In order to realize this operation, it is highly required to set beforehand the non-alarm area. However, setting the non-alarm area is required in some cases to enter a latitude and a longitude or an address. This setting work is cumbersome for a user.

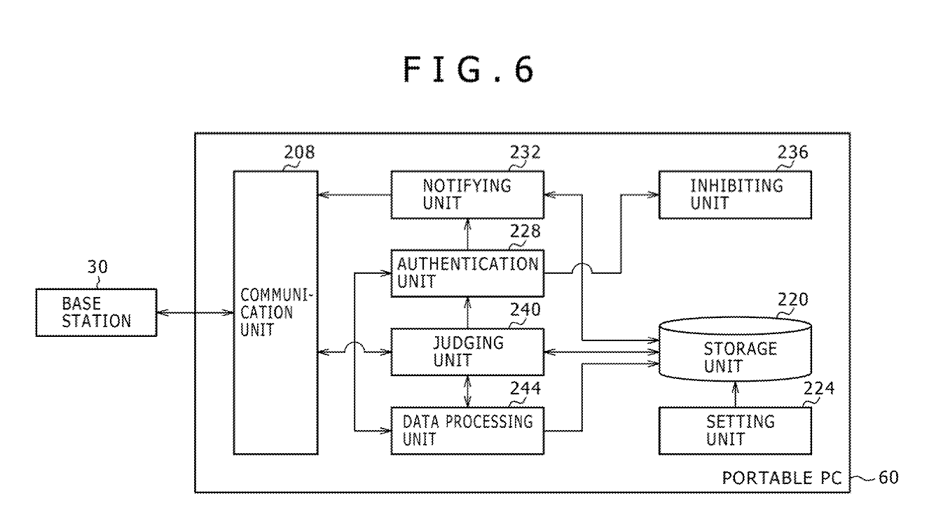

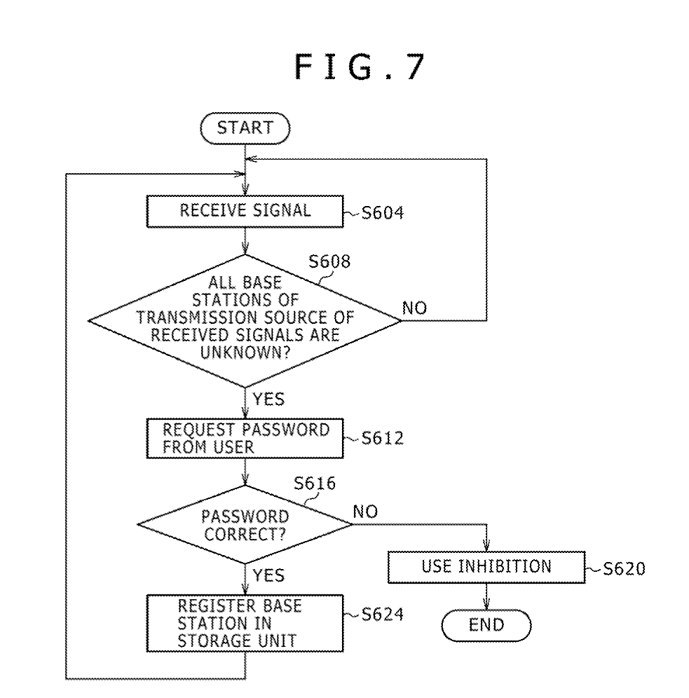

To overcome this work, a portable PC 60 of the second embodiment is provided with a data processing unit 244 capable of automatically updating an area satisfying a predetermined criterion, to thereby provide a user with a more simpler communication apparatus protecting method. With reference to FIGS. 6 and 7, description will be made on the detailed structure and operation of the portable PC 60 of the second embodiment. Constituent elements having substantially the same function and structure as those described in the first embodiment are represented by identical reference numerals, and the duplicated description thereof is omitted.

FIG. 6 is a functional block diagram showing the structure of the portable PC 60 of one embodiment of the present invention. The portable PC 60 has a communication unit 208, a storage unit 220, a setting unit 224, an authentication unit 228, a notifying unit 232, an inhibiting unit 236, a judging unit 240 and a data processing unit 244.

The storage unit 220 stores a base station ID in place of the information for identifying the range of the non-alarm area described in the first embodiment. The base station ID stored in the storage unit 220 is used when the judging unit 240 judges whether the portable PC 60 is in an area satisfying a predetermined criterion.

In accordance with a signal received via the communication unit 208, the judging unit 240 judges whether the portable PC 60 is located in the non-alarm area as the area satisfying the predetermined criterion. More in detail, the judging unit 240 judges whether the portable PC 60 is located in the non-alarm area, by comparing base ID's indicating base stations which are transmission sources of signals received at the communication unit 208, with the base station ID's stored in the storage unit 220.

For example, the judging unit 240 judges that the portable PC 60 is located in an alarm area, if the number or a ratio of base station ID's indicating base stations which are transmission sources of signals received at the communication unit 208, relative to base station ID's stored in the storage unit 220, is lower than a first boundary value. The first boundary value is an arbitrary number such as “3” and “10” or an arbitrary ratio such as “20%” and “50%”.

With this arrangement, the non-alarm area as the area satisfying the predetermined criterion corresponds to an area where the number or a ratio of signals capable of being received from base stations corresponding to base station ID's stored in the storage unit 220 is larger than the first boundary value. Therefore, if there are few or no signals capable of being received from base stations corresponding to base station ID's stored in the storage unit 220, the judging unit 220 judges that the portable PC 60 is not located in the area satisfying the criterion.

Further, the judging unit 240 judges that the portable PC 60 is located in an alarm area, if the number or a ratio of base ID's indicating base stations which are transmission sources of signals received at the communication unit 208, relative to base station ID's not stored in the storage unit 220, is larger than a second boundary value. Similar to the first boundary value, the second boundary value is an arbitrary number such as “12” and “20” or an arbitrary ratio such as “45%” and “80%”.

With this arrangement, the non-alarm area as the area satisfying the predetermined criterion corresponds to an area where the number or a ratio of signals capable of being received from base stations corresponding to base station ID's stored in the storage unit 220 is smaller than the second boundary value. Therefore, if the number or a ratio of signals capable of being received from base stations corresponding to base station ID's stored in the storage unit 220 is large or high, the judging unit 220 judges that the portable PC 60 is not located in the area satisfying the criterion.

Similar to the first embodiment, as the judging unit 240 judges that the portable PC 60 is located in the alarm area, the authentication unit 228 requires that a user of the portable PC 60 undergoes a user authentication.

If the authentication unit 228 can authenticate the user, the data processing unit 244 of this embodiment newly registers in the storage unit 220 a base station ID not registered in the storage unit 220 among base station ID's received via the communication unit 208. With this arrangement, since a base ID is automatically stored in the storage unit 220, a work of setting the non-alarm area to the portable PC 60 can be omitted. Namely, with the data processing unit 244, a new area can be set easily to the portable PC 60, avoiding a problem that a user is forced to set basic positions of the position range of a new area such as a latitude, a longitude and an address, each time the portable PC 60 is moved to the new area.

Further, if the communication unit 208 does not receive a signal over a predetermined time from the base station corresponding to the base station ID stored in the storage unit 220, the data processing unit 244 may delete this base station ID from the storage unit 220. With this arrangement, the data processing unit 244 can automatically update the non-alarm area.

More in detail, if the base station ID is stored in the storage unit 220 at a working site once called by a user, the judging unit 240 recognizes this working site also as the non-alarm area. If the number of base station ID's at sites having a low possibility that the user calls again increases in the base station ID's stored in the storage unit 220, the range recognized by the judging unit 240 as the non-alarm area becomes excessively broad. The data processing unit 244 can therefore erase properly the base station ID corresponding to the site the user called only by chance, from the storage unit 220, to thereby optimize the range recognized by the judging unit 240 as the area satisfying the criterion.

The predetermined time as a trigger when the data processing unit 244 erases the base station ID from the storage unit 220 may be set by the setting unit 224.

The structure of the portable PC 60 of the embodiment has been described above. Next, the operation flow of the portable PC 60 of the embodiment will be described with reference to FIG. 7.

FIG. 7 is an illustrative diagram showing the operation flow of the portable PC 60 of the embodiment. First, the portable PC 60 receives signals from nearby base stations (S604). Thereafter, for example, the judging unit 240 judges whether there is the same base station ID stored in the storage unit 220 as those base station ID's which indicate the transmission sources of received signals (S608).

If it is judged at Step S608 by the judging unit 240 that there is the same base station ID stored in the storage unit 220 as those base station ID's which indicate the transmission sources of received signals, the flow returns to the process at S604. If it is judged by the judging unit 240 that there is no same base station ID stored in the storage unit 220 as those base station ID's which indicate the transmission sources of received signals, the authentication unit 228 requests, for example, a password from the user (S612). The authentication unit 228 judges whether the password entered by the user is correct (S616).

If it is judged at S616 by the authentication unit 228 that the entered password is correct, the data processing unit 244 resisters the base station ID indicating the transmission source of the received signal in the storage unit 220 (S624). If it is judged by the authentication unit 228 that the entered password is incorrect, the inhibiting unit 236 inhibits use of the portable PC 60 by the user (S620).

As described above, according to the portable PC 60 of the second embodiment of the present invention, since the base station ID is automatically stored in the storage unit 220 by the data processing unit 244, it is possible to omit a work of setting the non-alarm area to the portable PC 60. For example, if a registration request is issued to the data processing unit 244 at the home of a user, the data processing unit 244 registers in the storage unit 220 the base station ID indicting a transmission source of a signal capable of being received at the home of the user. It is therefore possible to set easily the home of the user as the non-alarm area satisfying the criterion.

The portable PC 60 of this embodiment is not necessary to obtain precise position information of the portable PC 60. Namely, it is not necessary to communicate with the position estimating apparatus 40 nor measure a signal intensity of a received signal. It is therefore possible to simplify the whole configuration of the communication apparatus protecting system and reduce cost. Further, the portable PC 60 can operate irrespective of whether or not the portable PC 60 can be connected to the position estimating apparatus 40.

The preferred embodiments of the present invention have been described with reference to the accompanying drawings. Obviously, the present invention is not limited only to the embodiments. It is apparent that those skilled in the art can think of various changes and modifications without departing from the range of the scope of appended claims. These changes and modifications are construed as belonging to the technical scope of the present invention.

For example, although the portable PC 20 and position estimating apparatus 40 are separately structured in the first embodiment, the position estimating function may be provided in the portable PC 20. More specifically, base station information may be stored in the storage unit 220 of the portable PC 20, and the portable PC 20 is provided with a position estimating unit capable of estimating position information in accordance with the base station information and signal intensity information. With this arrangement, it is not necessary for the portable PC 20 to access the position estimating apparatus 40 via a network to obtain the position information. Therefore, the portable PC 20 can obtain the position information speedily. Moreover, the branch judgement at S504 shown in FIG. 5 is not necessary, and the processes at S532, S536 and S540 can be omitted correspondingly.

Each step in the processes to be performed by the communication apparatus protecting system 10 in this specification contains not only a process to be performed time sequentially in the order described in the flow chart or sequential diagram but also a process to be performed parallel or independently without being processed time sequentially (e.g., a process by parallel processing or objects).

The present invention also provides a program for making a computer perform the above-described position information processing, and a storage medium storing the program.

It should be understood by those skilled in the art that various modifications, combinations, sub-combinations and alternations may occur depending on design requirements and other factors insofar as they are within the scope of the appended claims or the equivalents thereof.

The present application claims benefit of priority of Japanese patent Application No. 2006-313428 filed in the Japanese Patent Office on Nov. 20, 2006, the entire content of which being incorporated herein by reference.

What is claimed is:

1. A communication apparatus capable of wireless communications with one or more base stations, comprising:
a receiving unit configured to receive a signal transmitted from the base station;
a judging unit configured to judge whether the communication apparatus is located in an area satisfying a predetermined criterion, in accordance with the signal received at the receiving unit; and
an authentication unit configured to perform an authentication process for a user of the communication apparatus if the judging unit judges that the communication apparatus is not located in the area satisfying the criterion.

2. The communication apparatus according to claim 1, further comprising:
a measuring unit configured to measure a signal intensity of each signal received at the receiving unit; and
wherein if the communication apparatus estimated from the signal intensity measured by the measuring unit and known position information of the base station, is located in a preset area, the judging unit judges that the criterion is satisfied.

3. The communication apparatus according to claim 2, further comprising a notifying unit configured to notify the estimated position of the communication apparatus to a registered contact site if the authentication unit cannot authenticate a user of the communication apparatus.

4. The communication apparatus according to claim 2, wherein the authentication unit performs the authentication process for the user of the communication apparatus while the position of the communication apparatus cannot be estimated.

5. The communication apparatus according to claim 4, wherein, the authentication unit performs the authentication process for the user of the communication apparatus at a predetermined time interval while the position of the communication apparatus cannot be estimated.

6. The communication apparatus according to claim 2, wherein 1, the preset area is variable in accordance with a timing of judging by the judging unit.

7. The communication apparatus according to claim 1, further comprising:
a storage unit capable of storing base station identification information uniquely assigned to the base station or each of the base stations, and
wherein the judging unit compares base station identification information indicating a transmission source of each signal received at the receiving unit with the base station identification information stored in the storage unit, to judge whether the communication apparatus is located in the area satisfying the criterion.

8. The communication apparatus according to claim 7, wherein the judging unit judges that the communication apparatus is not located in the area satisfying the criterion, if the number or a ratio of pieces of the base station identification information indicating the transmission source of each signal received at the receiving unit, relative to pieces of the base station identification information stored in the storage unit, is smaller than a first boundary value.

9. The communication apparatus according to claim 7, wherein the judging unit judges that the communication apparatus is not located in the area satisfying the criterion, if the number or a ratio of pieces of the base station identification information indicating the transmission source of each signal received at the receiving unit, relative to pieces of the base station identification information not stored in the storage unit, is larger than a second boundary value.

10. The communication apparatus according to claim 8, further comprising a data processing unit configured to store, in the storage unit, base station identification information indicating the transmission source of each signal received at the receiving unit, and not stored in the storage unit, if the user of the communication apparatus is not authenticated by the authentication unit.

11. The communication apparatus according to claim 8, wherein the data processing unit deletes the base station identification information from the storage unit if the receiving unit does not receive a signal over a predetermined time period.

12. The communication apparatus according to claim 1, further comprising an inhibiting unit configured to inhibit use of the communication apparatus if the authentication unit cannot authenticate the user of the communication apparatus.

13. A communication apparatus protecting method for a communication apparatus capable of wireless communications with one or more base stations, the method comprising the steps of:
receiving a signal transmitted from the base station;
judging whether the communication apparatus is located in an area satisfying a predetermined criterion, in accordance with the received signal; and
performing an authentication process for a user of the communication apparatus, if it is judged that the communication apparatus is not located in the area satisfying the criterion.

14. A program for making a computer function as a communication apparatus, the communication apparatus being capable of wireless communications with one or more base stations and comprising:
receiving means for receiving a signal transmitted from the base station;
judging means for judging whether the communication apparatus is located in an area satisfying a predetermined criterion, in accordance with the signal received at the receiving means; and
authenticating means for performing an authentication process for a user of the communication apparatus if the judging means judges that the communication apparatus is not located in the area satisfying the criterion.
